(19) United States
(12) Patent Application Publication
(10) Pub. No.: US 2025/0336021 A1
(43) Pub. Date: Oct. 30, 2025

(54) CONTROLLER, CONTROL METHOD AND CONTROL SYSTEM

(71) Applicants: Mitsubishi Electric Corporation, TOKYO (JP); MITSUBISHI ELECTRIC RESEARCH LABORATORIES, INC., Cambridge, MA (US)

(72) Inventors: Kei OTA, TOKYO (JP); Devesh JHA, Cambridge, MA (US)

(73) Assignees: Mitsubishi Electric Corporation, TOKYO (JP); MITSUBISHI ELECTRIC RESEARCH LABORATORIES, INC., Cambridge, MA (US)

(21) Appl. No.: 18/649,340

(22) Filed: Apr. 29, 2024

(51) Int. Cl. G06T 1/00; G06T 7/70; G06V 10/26; G06V 20/50

(52) U.S. Cl. CPC G06T 1/0007; G06T 7/70; G06V 10/26; G06V 20/50; G06V 2201/06

(57) ABSTRACT

A computer of a controller acquires environment information indicating an observation result of an environment in which a target object to be operated by a control target is located, acquires instruction information indicating an instruction from a user to the control target, the instruction including an instruction related to the target object, generates object information indicating the target object based on the environment information by using a first inference model, the first inference model being configured to generate information indicating an arbitrary object based on information indicating an observation result of an environment in which the arbitrary object is located, and generates operation information specifying an operation of the control target which includes an operation with respect to the target object based on the instruction information and the object information by using a second inference model, the second inference model being configured to generate information specifying an operation of the control target which includes an operation with respect to an object based on information related to the object and information indicating an instruction which is related to the control target and includes an instruction related to the object.

### BACKGROUND OF THE INVENTION

### Field of the Invention

The present disclosure relates to a controller, a control method, and a control system that control a control target configured to perform a specified operation.

### Description of the Background Art

Conventionally, there is known a technology to control a control target such as a robot. For example, Japanese Patent Laying-Open No. 2016-203293 (PTL 1) discloses a picking device that detects a work piece as a detection target which is learned in advance from an image acquired by an imaging device, and operates a robot hand to grip the work piece based on position information of the work piece. Japanese Patent Laying-Open No. 2019-509905 (PTL 2) discloses a deep machine learning method for training a neural network so that an end effector of a robot can correctly grip an object based on an image acquired by a visual sensor. Japanese Patent Laying-Open No. 2020-168719 (PTL 3) discloses a robot system that generates a three-dimensional map based on image information acquired by a camera, calculates the position and posture of a work piece based on the three-dimensional map, and operates a robot hand to grip the work piece based on the position and posture of the work piece.

### CITATION LIST

### Patent Literature

PTL 1: Japanese Patent Laying-Open No. 2016-203293
PTL 2: Japanese Patent Laying-Open No. 2019-509905
PTL 3: Japanese Patent Laying-Open No. 2020-168719

### SUMMARY OF THE INVENTION

### Technical Problem

According to the technologies disclosed in PTL 1 to PTL 3, the controller can detect a specific object photographed in an image by learning in advance a detection target which is a specific object such as a work piece, and can control a control target such as a robot to operate the detected specific object. However, in the technologies described above, since the controller is learned to detect a specific object whose shape or the like is determined in advance, the controller cannot detect an arbitrary object whose shape or the like is not determined in advance, and thus has a lower versatility.

The present disclosure has been made in view of the aforementioned problems, and an object of the present disclosure is to provide a highly versatile control technology capable of controlling a control target to operate an arbitrary object.

### Solution to Problem

A controller of the present disclosure includes a storage that stores data to control a control target; and a computer that executes a process to control the control target. The computer acquires environment information indicating an observation result of an environment in which a target object to be operated by the control target is located, and acquires instruction information indicating an instruction from a user to the control target, the instruction including an instruction related to the target object, the computer includes a first inference unit that generates object information indicating the target object based on the acquired environment information by using a first inference model, the first inference model being configured to generate information indicating an arbitrary object based on information indicating an observation result of an environment in which the arbitrary object is located, and a second inference unit that generates operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and the computer is configured to execute a process to control the control target based on the operation information.

A control method of the present disclosure includes, as a process to be executed by a computer, acquiring environment information indicating an observation result of an environment in which a target object to be operated by the control target is located, acquiring instruction information indicating an instruction from a user to the control target, the instruction including an instruction related to the target object, generating object information indicating the target object based on the acquired environment information by using a first inference model, the first inference model being configured to generate information indicating an arbitrary object based on information indicating an observation result of an environment in which the arbitrary object is located, generating operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and executing a process to control the control target based on the operation information.

A control system of the present disclosure includes a controller that controls a control target and a server communicably connected to the controller. The server includes a computer that executes a process to cause the controller to control the control target. The computer acquires environment information indicating an observation result of an environment in which a target object to be operated by the control target is located, and acquires instruction information indicating an instruction from a user to the control target, the instruction including an instruction related to the target object, the computer includes a first inference unit that generates object information indicating the target object based on the acquired environment information by using a first inference model, the first inference model being configured to generate information indicating an arbitrary object based on information indicating an observation result of an environment in which the arbitrary object is located, and a second inference unit that generates operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and the computer is configured to generate control information to control the control target based on the operation information and output the control information to the controller.

### Advantageous Effects of Invention

According to the present disclosure, since the process to control the control target is executed by using a first inference model, the first inference model being configured to generate information indicating an arbitrary object based on information indicating an observation result of an environment in which the arbitrary object is located to generate object information indicating the target object based on the acquired environment information, and using a second inference model, the second inference model being configured to generate information specifying an operation of the control target which includes an operation with respect to an object based on information related to the object and information indicating an instruction related to the control target which includes an instruction related to the object to generate operation information specifying an operation of the control target which includes an operation with respect to the target object based on the instruction information and the object information, it is possible to control the control target to operate an arbitrary object.

### BRIEF DESCRIPTION OF THE DRAWINGS

FIG. 1 is a diagram illustrating a configuration of a control system according to a first embodiment;

FIG. 2 is a diagram illustrating a configuration of a controller according to the first embodiment;

FIG. 3 is a diagram illustrating a control system according to a comparative example;

FIG. 4 is a diagram for explaining main functions of the controller according to the first embodiment;

FIG. 5 is a diagram for explaining main functions of the controller according to the first embodiment;

FIG. 6 is a diagram for explaining an example operation of a robot controlled by the controller according to the first embodiment;

FIG. 7 is a diagram for explaining another example operation of a robot controlled by the controller according to the first embodiment;

FIG. 8 is a flowchart illustrating a process to be executed by the controller according to the first embodiment;

FIG. 9 is a diagram illustrating an example process of a controller in a control system according to a second embodiment;

FIG. 10 is a diagram illustrating a control system according to a third embodiment; and

FIG. 11 is a flowchart illustrating a process to be executed by a controller and a server in the control system according to the third embodiment.

### DESCRIPTION OF THE PREFERRED EMBODIMENTS

Hereinafter, embodiments will be described with reference to the drawings. Although a plurality of embodiments will be described below, proper combinations of components described in each embodiment are also originally intended. In the drawings, the same or corresponding portions are denoted by the same reference numerals, and the description thereof will not be repeated.

### First Embodiment

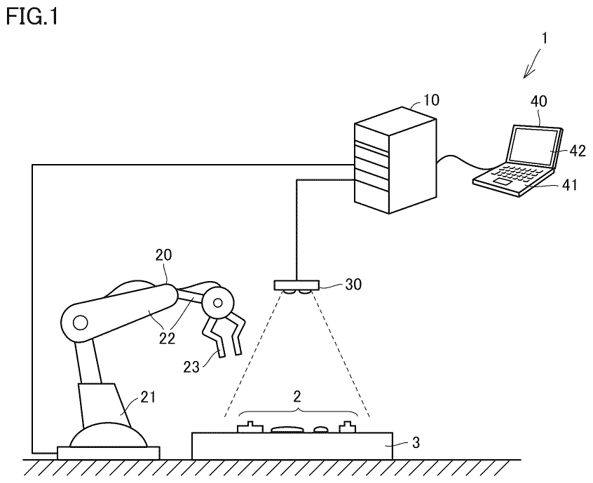

A control system 1 according to a first embodiment will be described with reference to FIGS. 1 to 8.

### Configuration of Control System

FIG. 1 is a diagram illustrating the configuration of the control system 1 according to the first embodiment. As illustrated in FIG. 1, the control system 1 according to the first embodiment includes a controller 10, a robot 20, a sensor 30, and a support device 40. For example, the control system 1 is located at a production site to which factory automation is applied, and the robot 20 is controlled by the controller 10 to perform operations such as taking out or moving a work piece 2.

The controller 10 is a programmable controller that controls the robot 20 to perform operations such as taking out or moving the work piece 2. The controller 10 is not limited to a programmable controller, and may be any device capable of controlling the robot 20.

The robot 20 is a device that is controlled by the controller 10 and is configured to perform an operation specified by the controller 10, and is an example of a “control target”. The robot 20 includes a base 21, an arm 22 connected to the base 21, and an end effector 23 attached to a distal end of the arm 22. Under the control of the controller 10, the robot 20 moves the arm 22 to bring the end effector 23 close to a stage 3 on which the work piece 2 is located, and uses the end effector 23 to grip the work piece 2. Note that the “control target” is not limited to a robot, and may include any device that can operate under the control of the controller 10, such as an actuator of a vehicle.

The work piece 2 includes a component, a product in process or the like to be operated by the robot 20, and is an example of a “target object”. For example, in a production site to which the control system 1 is applied, the work piece 2 is gripped and taken out by the end effector 23 of the robot 20 and moved to a predetermined location. In a production site, the target object of the robot 20 includes a wide variety of work pieces 2, and the attributes of each of the work pieces 2, such as the shape, the weight, the friction coefficient, the center of gravity, the inertia moment, or the rigidity thereof may be different from each other. In other words, the work piece 2 to be handled by the robot 20 is not a specific object that can be grasped in advance by the controller 10, but is an “arbitrary object” that is difficult to be grasped in advance by the controller 10.

The sensor 30 observes a working environment of the robot 20 such as the stage 3 on which the work piece 2 is located, and outputs environment information indicating the observation result to the controller 10. The sensor 30 includes an image sensor capable of photographing an image or a video of the working environment. In other words, the environment information includes an environment image obtained by photographing the environment in which the work piece 2 is located. In the first embodiment, an RGB-D camera capable of acquiring not only a color image indicating a working environment but also a distance between the sensor 30 and the work piece 2 is applied to the sensor 30. The sensor 30 to which the RGB-D camera is applied can acquire color data (RGB data) representing the work piece 2 located in the working environment in red, green and blue colors, and position data (depth data) representing coordinates of each point in a point group constituting the work piece 2 in the depth direction.

Note that the sensor 30 is not limited to being fixed at a predetermined position, it may be attached to the robot 20. For example, the sensor 30 may be located on the end effector 23 of the robot 20 so as to capture an image of the working environment and periodically acquire a distance between the robot 20 and the work piece 2.

Note that the sensor 30 may include other sensors such as a sound sensor capable of acquiring sound of the working environment, a force sensor capable of detecting a magnitude or a rotation direction of a force applied to the work piece 2 located in the working environment, or a contact sensor capable of detecting a distance to the work piece 2.

The support device 40 provides a user interface that is used by a user to input instruction information indicating an instruction from the user to the robot 20, the instruction including a program to control the robot 20 or an instruction related to the work piece 2 to the controller 10, and to acquire image information for displaying a control result or the like of the robot 20 from the controller 10. For example, the support device 40 includes an input unit 41 including a mouse, a touch pad, or a keyboard. In order to cause the robot 20 to perform a desired operation, the user can use the input unit 41 to input instruction information for instructing the robot 20 to the controller 10. The support device 40 includes a display 42. The support device 40 can display a control result of the robot 20 or the like on the display 42 based on the image information acquired from the controller 10.

The support device 40 may be a personal computer (PC) such as a desktop computer, a laptop computer or a tablet computer, or a mobile terminal such as a smartphone. The function of the support device 40 may be included in the controller 10. In other words, the user may directly operate the controller 10 to input a program or instruction information to control the robot 20 to the controller 10.

### Configuration of Controller

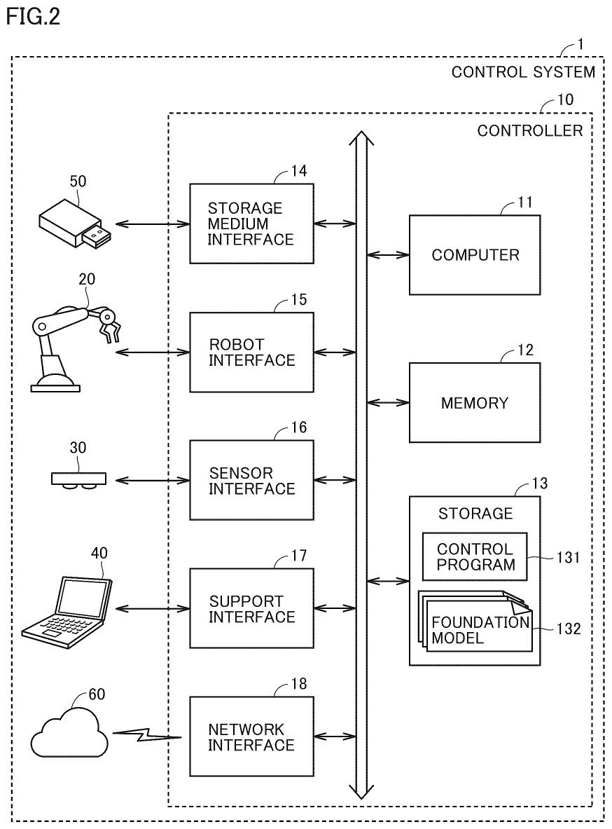

FIG. 2 is a diagram illustrating a configuration of a controller according to the first embodiment. As illustrated in FIG. 2, the controller 10 includes a computer 11, a memory 12, a storage 13, a storage medium interface 14, a robot interface 15, a sensor interface 16, a support interface 17, and a network interface 18.

The computer 11 is a computing entity (computer) that executes a predetermined process. The computer 11 is constituted by a processor such as a CPU (Central Processing Unit), a MPU (Micro-Processing Unit), a TPU (Tensor Processing Unit), or a GPU (Graphics Processing Unit). Note that a processor which is an example of the computer 11 has a function of executing a predetermined process by executing a predetermined program, and a part or all of these functions may be implemented by using a dedicated hardware circuit such as an ASIC (Application Specific Integrated Circuit) or an FPGA (Field-Programmable Gate Array). The “processor” is not limited to a processor in a narrow sense, such as a CPU, a MPU, a TPU, or a GPU that performs a process in a stored program manner, and may include a hardwired circuit such as an ASIC or FPGA. The computer 11 is not limited to a Neumann computer such as a CPU or a GPU, and may be a non-Neumann computer such as a quantum computer or an optical computer. The computer 11 may be replaced with a processing circuitry. Note that the computer 11 may be constituted by one chip or may be constituted by a plurality of chips. Further, the processor and associated processing circuitry may be constituted by a plurality of computers interconnected in a wired or wireless manner, such as via a local area network or a wireless network. The processor and associated processing circuitry may be constituted by a cloud computer that performs remote operations based on input information and outputs operation results to other remotely located devices.

The memory 12 includes a storage area (for example, a working area) for storing a program code, a work memory or the like when the computer 11 executes various programs. Examples of the memory 12 include volatile memories such as DRAM (Dynamic Random Access Memory) and SRAM (Static Random Access Memory), or nonvolatile memories such as ROM (Read Only Memory) and flash memory. The memory 12 may be replaced with a processing circuit having a function of holding data or a signal.

The storage 13 stores various data such as various programs to be executed by the computer 11. For example, the storage 13 stores a control program 131 to be executed by the computer 11 and one or more foundation models 132. The storage 13 may be one or more non-transitory computer-readable media or may be one or more computer-readable storage media. Examples of the storage 13 include a hard disk drive (HDD) and a solid state drive (SSD). The memory device 13 may be replaced with a processing circuit having a function of holding data or a signal.

The control program 131 defines a processing procedure for the controller 10 to control the robot 20.

The foundation model 132 is an inference model used by the controller 10 to identify a work piece 2 or determine an operation to be performed by the controller 10, and includes foundation models 132A to 132D which will be described later. Hereinafter, the foundation models 132A to 132D will also be collectively referred to as the “foundation model 132”. The foundation model 132 is a large-scale artificial intelligence model which has been trained to infer predetermined information by, for example, self-supervised learning or semi-supervised learning based on a large amount of Internet-scale data. The learning algorithm of the foundation model 132 may be reinforcement learning or unsupervised learning, or may be deep learning, genetic programs, functional logic programs, or other known algorithms. The foundation model 132 is one type of Artificial Intelligence (AI). The foundation model 132 may be an inference model in which a learning target is not specified, in other words, machine learning is performed on a non-specific learning target. Since the learning target is not specified, the foundation model 132 can infer an output based on the input information even if the information that is not learned is input, and thus has a high versatility. The functions of each of the foundation models 132A to 132D will be described later in detail.

In the present disclosure, the term “learning model” is used as a term for comparison with the “foundation model”. In the learning model, machine learning is performed only on a specific learning target determined in advance. Since the learning target is specified, the learning model cannot infer an output when information that is not learned is input, and has a lower versatility than the foundation model 132.

The storage medium interface 14 is an interface that is communicably connected to the storage medium 50 for acquiring various data such as a program (for example, a control program 131) stored in the storage medium 50, or outputting data stored in the storage 13 to the storage medium 50. The storage medium 50 may include any storage medium capable of storing various kinds of data, such as a compact disc (CD), a digital versatile disc (DVD), or a universal serial bus (USB) memory. Data read from the storage medium 50 via the storage medium interface 14 is stored in the storage 13 and referenced by the computer 11.

The robot interface 15 is an interface for outputting, to the robot 20, control information generated by the computer 11 to control the robot 20. The control information indicates control contents for the robot 20.

The sensor interface 16 is an interface that is communicably connected to the sensor 30 for acquiring, from the sensor 30, environment information indicating an observation result of a working environment in which the work piece 2 is located. The support interface 17 is an interface that is communicably connected to the support device 40 for acquiring a program (for example, the control program 131) input by a user or instruction information for the robot 20 from the support device 40, or outputting image information for displaying a control result or the like of the robot 20 generated by the controller 10 to the support device 40.

The network interface 18 is an interface that is communicably connected to the Internet 60 for acquiring various kinds of information from the Internet 60.

### Control System of Comparative Example

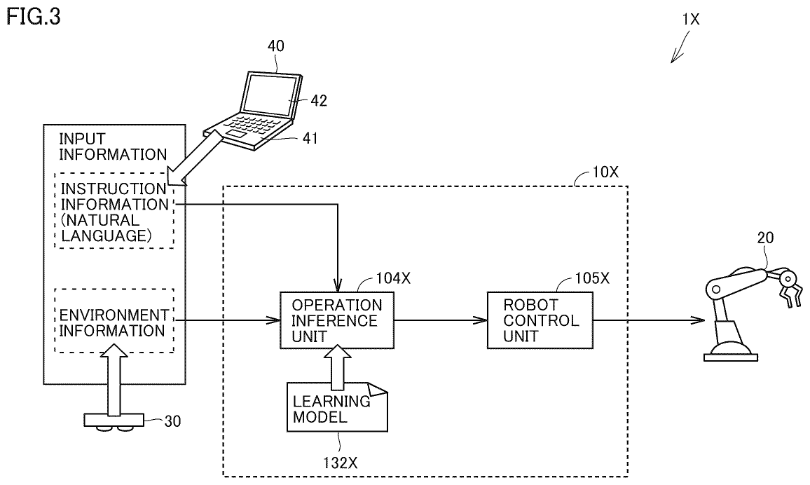

FIG. 3 is a diagram illustrating a control system 1X according to a comparative example. As illustrated in FIG. 3, in the control system 1X, a controller 10X includes an operation inference unit 104X and a robot control unit 105X as main functional units. The operation inference unit 104X and the robot control unit 105X are functions that can be implemented by a computer (not shown) included in the controller 10X.

The user uses the input unit 41 of the support device 40 to generate instruction information indicating an instruction from the user to the robot 20 in a natural language sentence. The instruction information includes a natural language sentence indicating at least one task to be assigned to the robot 20. The instruction information generated by the user is input from the support device 40 to the controller 10X. The sensor 30 observes the working environment of the robot 20 by photographing the working environment or the like, and generates environment information indicating an observation result of the working environment. The environment information is input from the sensor 30 to the controller 10X.

In the controller 10X, the operation inference unit 104X acquires instruction information input from the support device 40, and acquires environment information from the sensor 30. The operation inference unit 104X detects the position of a work piece 2 located in the working environment based on the environment information, and generates operation information specifying an operation of the robot 20 based on the instruction information and the detection result. The robot control unit 105X generates control information to control the robot 20 based on the operation information generated by the operation inference unit 104X, and outputs the control information to the robot 20.

As described above, in the control system 1X according to the comparative example, the controller 10X can generate control information to control the robot 20 based on the instruction information generated by the user and the environment information acquired by the sensor 30.

In the comparative example, although the operation inference unit 104X is configured to detect the position, the posture or the like of the work piece 2 located in the working environment based on the environment information acquired by the sensor 30, it detects only a specific work piece 2 whose shape or the like is determined in advance. For example, the controller 10X includes a learning model 132X in which attributes such as a predetermined shape, a weight, a friction coefficient, a center of gravity, an inertia moment, or a rigidity of a specific work piece 2 are machine-learned by using a technique such as supervised learning. The learning model 132X can refer to an image of the work piece 2 located in the working environment included in the input environment information, and can detect the position, the posture or the like of the work piece 2 photographed in the image only when the work piece 2 photographed in the image is a specific work piece 2 already subjected to the machine learning.

However, as described above, in a production site to which the control system 1 according to the first embodiment is applied, the target object of the robot 20 includes a wide variety of work pieces 2, and the attributes of the work pieces 2, such as the shape, the weight, the friction coefficient, the center of gravity, the inertia moment, or the rigidity thereof may be different from each other. In the controller 10X according to the comparative example, when learning is performed so as to detect only a specific work piece 2 whose shape or the like is determined in advance, it is impossible to detect an arbitrary work piece 2 whose shape or the like is not determined in advance. Therefore, when a work piece 2 that is not learned by the learning model 132X is located in the working environment, the controller 10X cannot detect an arbitrary work piece 2 by using the learning model 132X, and the user needs to manually operate the robot 20 or relearn the learning model 132X. As described above, the controller 10X according to the comparative example cannot detect a work piece 2 whose shape or the like is not determined in advance, and thus has a lower versatility.

Therefore, in the control system 1 according to the first embodiment, the controller 10 is configured to provide a versatile control to operate the robot 20 with respect to an arbitrary work piece 2. Hereinafter, a process to control the robot 20 by the controller 10 according to the first embodiment will be described.

### Main Functions of Controller

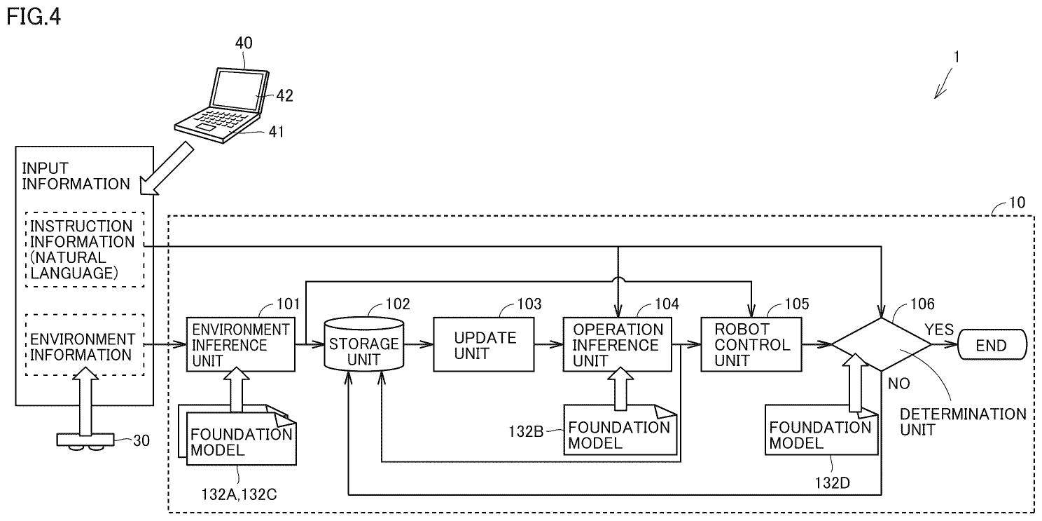

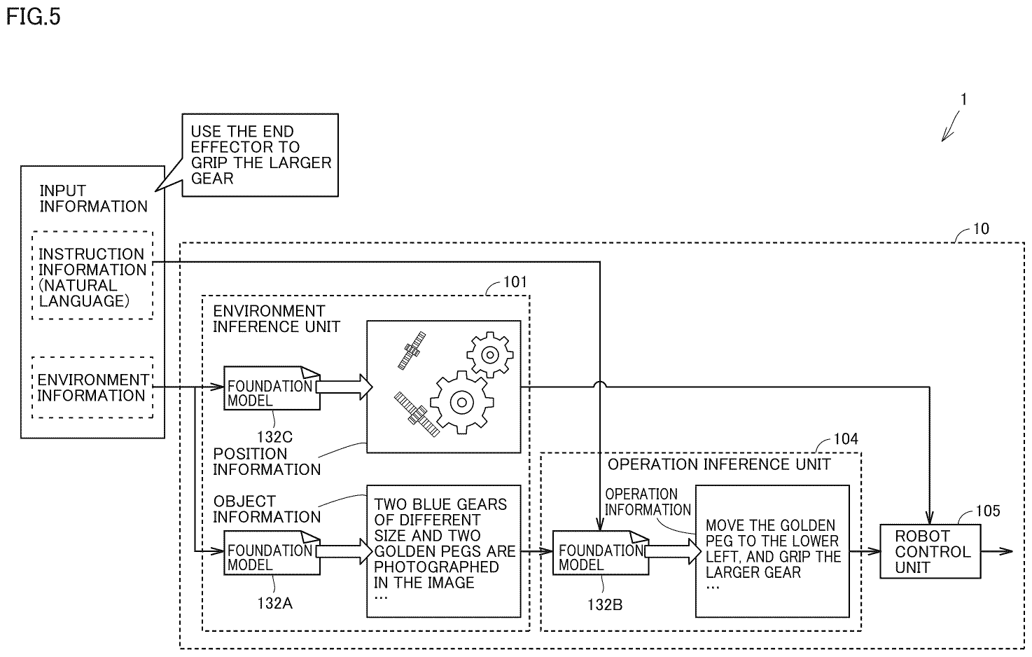

FIGS. 4 and 5 are diagrams for explaining main functions of the controller 10 according to the first embodiment. As illustrated in FIG. 4, the controller 10 includes an environment inference unit 101, a storage unit 102, an update unit 103, an operation inference unit 104, a robot control unit 105, and a determination unit 106 as main functional units. The environment inference unit 101, the storage unit 102, the update unit 103, the operation inference unit 104, the robot control unit 105, and the determination unit 106 are functions that can be implemented by the computer 11 of the controller 10.

The user uses the input unit 41 of the support device 40 to generate instruction information indicating an instruction from the user to the robot 20 in a natural language sentence. The instruction information includes a natural language sentence indicating at least one task to be assigned to the robot 20. For example, as illustrated in FIG. 5, the instruction information includes a sentence that instructs the robot to use the end effector 23 to grip the larger gear (the work piece 2). Note that the instruction information may include a conditional statement that limits objects to be operated. Further, the instruction information may include a sentence or an image indicating a state (a state after operation) obtained as a result of the robot 20 performing a desired operation on the work piece 2. The instruction information generated by the user is input from the support device 40 to the controller 10.

Returning to FIG. 4, the sensor 30 observes the working environment of the robot 20 by photographing the working environment or the like, and generates environment information indicating an observation result of the working environment. The environment information is input from the sensor 30 to the controller 10.

In the controller 10, the environment inference unit 101 acquires the environment information from the sensor 30. The environment information acquired by the environment inference unit 101 includes RGB data of an image indicating the work piece 2 located in the working environment. The environment inference unit 101 generates object information indicating the work piece 2 located in the working environment included in the environment information based on the environment information by using the foundation model 132A.

The foundation model 132A is configured (trained) to generate information indicating an arbitrary object based on information indicating an observation result of an environment in which the arbitrary object is located, and is an example of a “first inference model”. Specifically, the foundation model 132A depicts an arbitrary object photographed in the image by using a natural language sentence, and generates object information which includes the natural language sentence indicating the arbitrary object. The object information generated by the controller 10 by using the foundation model 132A includes, for example, a name, a shape, a color, a size, and a position of the work piece 2. The processing and function of the computer 11 of the controller 10 by using the foundation model 132A (first inference model) are an example of a “first inference unit”.

For example, as illustrated in FIG. 5, when the environment information is input from the sensor 30, the foundation model 132A refers to the image of the work piece 2 located in the working environment included in the environment information, and depicts the work piece 2 photographed in the image by using a natural language sentence even if the work piece 2 photographed in the image is an arbitrary work piece 2 that is initially found.

For example, when two blue gears of different size and two golden pegs are photographed as the work piece 2 in an image acquired by the sensor 30, the foundation model 132A generates a sentence indicating that two blue gears of different size and two golden pegs are photographed in the image based on the environment information. The foundation model 132A can depict the work pieces 2 photographed in the image by using a natural language sentence even if the two blue gears of different size and the two golden pegs are not learned in advance.

Further, the environment inference unit 101 may use the foundation model 132C to acquire the position information of the work piece 2 in the image by segmenting the work piece 2 in the image based on the environment information.

The foundation model 132C is configured (trained) to segment an object included in an image based on the image including the object, and is an example of a “third inference model”. For example, the foundation model 132C is configured to segment an arbitrary object included in an image based on the image including the arbitrary object. Specifically, the foundation model 132C segments an arbitrary object photographed in the image in a distinguishable manner, and specifies position information of each point in a point group constituting the segmented object. Note that the foundation model 132C can specify the shape of the segmented object by specifying the position information of each point in the point group constituting the segmented object. The processing and function of the computer 11 of the controller 10 by using the foundation model 132C (third inference model) are an example of a “third inference unit”.

For example, as illustrated in FIG. 5, when the environment information is input from the sensor 30, the foundation model 132C refers to the image of the work piece 2 located in the working environment included in the environment information, and specifies the position information of the work piece 2 in the image by segmenting the work piece 2 photographed in the image even if the work piece 2 photographed in the image is an arbitrary work piece 2 that is initially found.

For example, when two blue gears of different size and two gold pegs are photographed in an image acquired by the sensor 30, the foundation model 132C segments each of the plurality of work pieces 2 in the image in a distinguishable manner based on the environment information. The environment inference unit 101 can specify the position information of each point in the point group constituting each work piece 2 by using the foundation model 132C to segment each work piece 2 in the image. The foundation model 132C is capable of segmenting these work pieces 2 from each other in the image in a distinguishable manner even if the two blue gears of different size and the two gold pegs are not learned in advance. The segmentation performed by the foundation model 132C may be referred to as an instance segmentation, a semantic segmentation, or a panoptic segmentation, for example. The instance segmentation refers to specifying regions of an object in an image and distinguishing the regions of each object. The semantic segmentation refers to assigning semantics to each pixel according to the subject type of each pixel included in an image (labeling, categorizing or the like according to the subject type). In addition, the panoptic segmentation refers to assigning semantics to each pixel according to each subject of each pixel included in an image (labeling, categorizing or the like according to each subject). For example, the environment inference unit 101 may be configured to select a segmentation to be performed from a plurality of segmentations that have been implemented in advance as described above.

Returning to FIG. 4, the environment inference unit 101 outputs the object information which includes a sentence generated by using the foundation model 132A to the storage unit 102. The storage unit 102 stores the object information generated by the environment inference unit 101 in the storage 13. Each time the storage unit 102 acquires the object information from the environment inference unit 101, it stores the acquired object information in the storage 13. Therefore, the storage 13 accumulatively stores object information generated in the past.

Further, the environment inference unit 101 outputs the position information of the work piece 2 acquired by using the foundation model 132C to the robot control unit 105.

The operation inference unit 104 acquires the instruction information from the support device 40, and acquires the object information generated by the environment inference unit 101 from the storage 13. The operation inference unit 104 uses the foundation model 132B to generate operation information specifying an operation of the robot 20 based on the instruction information and the object information. At this time, the operation inference unit 104 further acquires past information (for example, past object information, past instruction information, past operation information, and past result information to be described later) accumulated and stored in the storage 13, and generates operation information based on the past information.

The foundation model 132B is configured (trained) to generate information specifying an operation of the robot 20 which includes an operation with respect to an object based on information related to the object and information indicating an instruction to the robot 20 and including an instruction related to the object, and is an example of a “second inference model”. For example, the foundation model 132B is configured to generate information specifying an operation of the robot 20 which includes an operation with respect to an arbitrary object based on information indicating the arbitrary object as the information related to the object. Specifically, the foundation model 132B generates a natural language sentence specifying an operation of the robot 20 based on the natural language sentence depicting an arbitrary work piece 2 included in the object information generated by the environment inference unit 101 and the natural language sentence indicating the instruction from the user to the robot 20 and included in the instruction information input by the user. The processing and function of the computer 11 of the controller 10 by using the foundation model 132B (second inference model) are an example of a “second inference unit”.

For example, as illustrated in FIG. 5, in order to cause the robot 20 to grip the larger gear in accordance with the instruction information input by the user, the foundation model 132B generates a natural language sentence instructing the robot 20 to perform an operation by moving the golden peg to the lower left based on the object information generated by the foundation model 132A and then griping the larger gear.

Returning to FIG. 4, the operation inference unit 104 outputs the operation information including the generated sentence to the robot control unit 105. In addition, the operation inference unit 104 outputs the operation information to the storage unit 102. The storage unit 102 stores the operation information generated by the operation inference unit 104 in the storage 13. Each time the storage unit 102 acquires the operation information from the operation inference unit 104, it stores the acquired operation information in the storage 13. Therefore, the storage 13 accumulatively stores operation information generated in the past.

The robot control unit 105 acquires the position information of the work piece 2 acquired by the environment inference unit 101. Further, the robot control unit 105 acquires the operation information generated by the operation inference unit 104. The robot control unit 105 generates control information to control the robot 20 based on the position information and the operation information, and outputs the control information to the robot 20. The control information includes commands for operating the robot 20, such as an articulation angle, an angular velocity and a torque of the arm 22, and a gripper opening/closing width of the end effector 23. The robot 20 is operated in accordance with the control information output from the controller 10. Note that the control information may include a command for correcting a control by a prescribed program of the robot 20. In addition, the control information may include a control program which rewrites the prescribed program of the robot 20 so as to execute the corrected control.

The determination unit 106 determines whether or not an operation of the robot 20 according to the control information is correct by using the foundation model 132D. Specifically, the determination unit 106 determines whether or not the robot 20 has been correctly operated as instructed by the user based on the instruction information generated by the user, the control information generated by the robot control unit 105, and the operation result of the robot 20 according to the control information.

The foundation model 132D is configured (trained) to generate a natural language sentence indicating a determination result regarding whether or not the operation of the robot 20 is correct, and is an example of a “fourth inference model”. For example, the foundation model 132D is configured to determine whether or not an operation of the robot 20 is correct based on the information indicating the control instruction for the robot 20, the information indicating the control content for the robot 20, and the information indicating the operation result of the robot 20 according to the control information. Specifically, the foundation model 132D determines whether or not the robot 20 is controlled according to the instruction from the user based on the natural language sentence indicating the instruction from the user to the robot 20 and included in the instruction information input by the user, and the control information generated by the robot control unit 105, in other words, the operation information including the natural language sentence generated by the operation inferring unit 104 for specifying the operation of the robot 20. Further, the foundation model 132D checks the working environment after the operation of the robot 20, and determines whether or not the robot 20 has been operated as instructed by the user. The foundation model 132D generates a natural language sentence indicating these determination results. The processing and function of the computer 11 of the controller 10 by using the foundation model 132D (fourth inference model) are an example of a “fourth inference unit”.

When the operation of the robot 20 is correct, the determination unit 106 ends the current control of the robot 20. On the other hand, when the operation of the robot 20 is not correct, the determination unit 106 outputs the instruction information input by the user and the result information which includes a natural language sentence indicating the determination result to the storage unit 102. The storage unit 102 stores the instruction information input by the user and the result information generated by the determination unit 106 in the storage 13. Each time the storage unit 102 acquires the instruction information and the result information from the determination unit 106, it stores the acquired instruction information and result information in the storage 13. Therefore, the storage 13 accumulatively stores the instruction information and the result information generated in the past.

When the determination unit 106 determines that the operation of the robot 20 is not correct, the update unit 103 updates the information related to the work piece 2 based on the object information, the operation information, the instruction information, and the result information stored in the storage 13. The operation inference unit 104 generates new operation information based on the information related to the work piece 2 which is updated by the update unit 103 based on the information (for example, the object information, the instruction information, the operation information, and the result information) accumulated and stored in the storage 13. As described above, when the operation of the robot 20 according to the control information is not correct, the controller 10 generates a new natural language sentence specifying the operation of the robot 20 based on a history of the past instruction information, the past operation information, and the like. The operation inference unit 104 outputs the new operation information including the newly generated sentence to the robot control unit 105.

The robot control unit 105 acquires the position information of the work piece 2 acquired by the environment inference unit 101. Further, the robot control unit 105 acquires the new operation information generated by the operation inference unit 104. The robot control unit 105 generates control information to control the robot 20 based on the position information and the new operation information, and outputs the control information to the robot 20. The robot 20 is operated again in accordance with the control information output from the controller 10.

As described above, since the controller 10 generates the operation information based on the information (for example, the object information, the instruction information, the operation information, and the result information) during a failed operation in the past, it is possible to operate the robot 20 as instructed by the user with higher accuracy by using the control information generated based on the operation information.

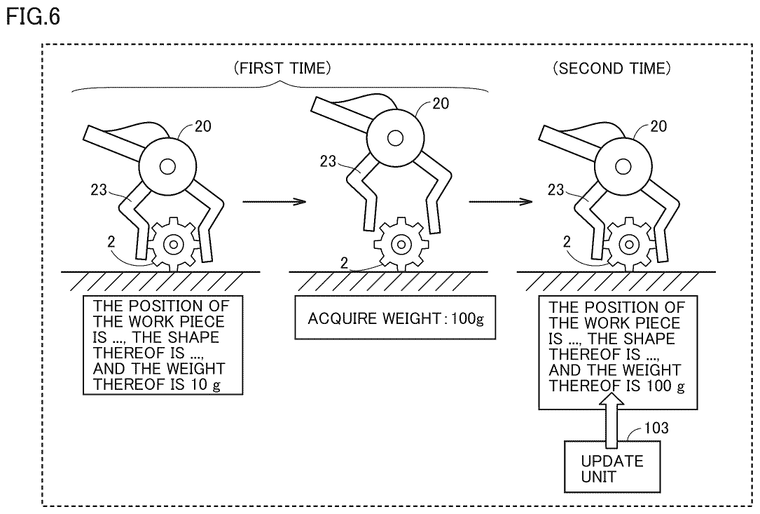

For example, FIG. 6 is a diagram for explaining an example operation of the robot 20 controlled by the controller 10 according to the first embodiment. As illustrated in FIG. 6, the controller 10 determines the position, the shape, the weight, and the like of the work piece 2 based on the information stored in the storage 13. When recognizing that the weight of the work piece 2 is 10 g, the controller 10 generates a first control command to adjust the torque or the like in accordance with the weight (10 g) of the work piece 2, and operates the robot 20.

If the weight of the work piece 2 is 100 g, which is larger than the assumed weight of 10 g, and the robot 20 is unable to successfully grip the work piece 2, the controller 10 generates a second control command for adjusting the torque or the like in accordance with the weight (100 g) of the work piece 2 based on the information (for example, the object information, the instruction information, the operation information, and the result information) during the failed operation, and operates the robot 20 again.

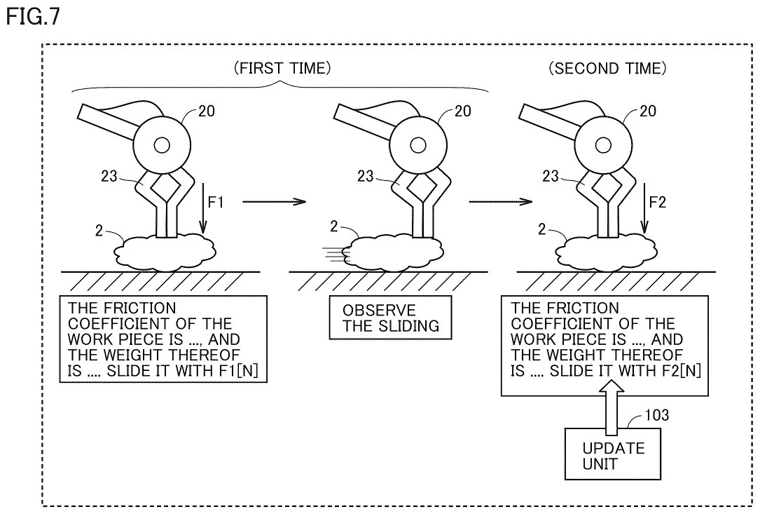

FIG. 7 is a diagram for explaining another example operation of the robot 20 controlled by the controller according to the first embodiment. As illustrated in FIG. 7, the controller 10 determines the friction coefficient, the weight, and the like of the work piece 2 based on the information stored in the storage 13. When recognizing that the friction coefficient of the work piece 2 is F1, the controller 10 generates a first control command for adjusting the torque or the like in accordance with the friction coefficient (F1) of the work piece 2, and operates the robot 20.

If the friction coefficient of the work piece 2 is F2, which is larger than the assumed F1, and the robot 20 is unable to successfully slide the work piece 2, the controller 10 generates a second control command for adjusting the torque or the like in accordance with the friction coefficient (F2) of the work piece 2 based on the information (for example, the object information, the instruction information, the operation information, and the result information) during a failed operation, and operates the robot 20 again.

As described above, since the controller 10 generates a new control command by using a history of the operation information and the like during a failed operation in the past as new input data, it is possible to operate the robot 20 as instructed by the user with higher accuracy. The foundation model trained to detect an arbitrary work piece 2 whose shape or the like is not determined in advance, such as the foundation model 132 used by the controller 10 according to the first embodiment, has higher versatility than the learning model 132X trained to detect only a specific work piece 2 whose shape or the like is determined in advance, such as the controller 10X according to the comparative example illustrated in FIG. 3, but may have a low accuracy in detecting the state of the work piece 2. However, as described above, when the operation of the robot 20 is failed, the controller 10 autonomously updates the information related to the work piece 2 based on the past information stored in the storage 13, generates new operation information based on the updated result, and generates a new control command to control the robot 20, the robot 20 can be operated more accurately as instructed by the user.

### Process by Controller

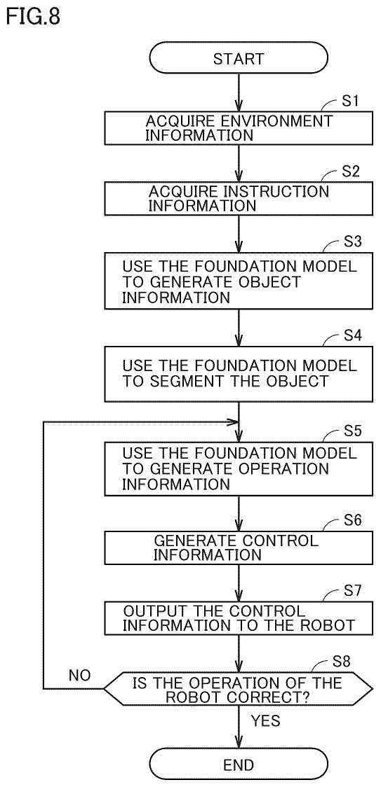

FIG. 8 is a flowchart illustrating a process to be executed by the controller 10 according to the first embodiment. The processing steps of the controller 10 are implemented by the computer 11 executing the control program 131.

As illustrated in FIG. 8, the controller 10 acquires, from the sensor 30, environment information indicating an observation result of an environment in which the work piece 2 is located (S1). The controller 10 acquires, from the support device 40, instruction information indicating an instruction from the user to the robot 20 (S2). The controller 10 depicts the work piece 2 photographed in the image by using the natural language sentence based on the environment information, and generates object information which includes the natural language sentence indicating the work piece 2 by using the foundation model 132A (S3). The controller 10 uses the foundation model 132C to segment the work piece 2 photographed in the image in a distinguishable manner based on the environment information, and specify the position information of each point in the point group constituting the segmented work piece 2 (S4).

The controller 10 uses the foundation model 132B to generate operation information specifying an operation of the robot 20 based on the instruction information and the object information (S5). The controller 10 generates control information to control the robot 20 based on the position information and the operation information (S6). The controller 10 outputs the control information to the robot 20 (S7).

The controller 10 uses the foundation model 132D to determine whether or not the operation of the robot 20 is correct based on the instruction information, the control information, and the operation result of the robot 20 (S8). When the operation of the robot 20 is not correct (NO in S8), the controller 10 returns to the step S5, and generates new operation information specifying the operation of the robot 20. On the other hand, when the operation of the robot 20 is correct (YES in S8), the controller 10 ends the process related to the present flow.

As described above, in the control system 1, the controller 10 can use the foundation model 132A trained to generate the information indicating the arbitrary work piece 2 to generate the object information indicating the work piece 2 based on the observation result of the environment in which the work piece 2 is located, specify the operation of the robot 20 based on the object information, and control the robot 20. Accordingly, the controller 10 can operate the robot 20 with respect to an arbitrary work piece 2. Thus, the controller 10 can provide a versatile control to operate the robot 20 with respect to an arbitrary work piece 2.

The controller 10 can use the foundation model 132B to generate a natural language sentence that specifies the operation of the robot 20 with respect to an arbitrary work piece 2 based on a natural language sentence indicating the arbitrary work piece 2 included in the object information and a natural language sentence indicating an instruction from the user to the robot 20 and included in the instruction information input by the user.

The controller 10 can use the foundation model 132C to segment the work piece 2 based on the environment information so as to determine the position and the shape of the work piece 2 with high accuracy.

The controller 10 can use the foundation model 132D to indicate the determination result regarding whether or not the operation of the robot 20 according to the control information is correct in a natural language sentence.

The controller 10 can use the foundation model 132 to represent each of the object information indicating the work piece 2, the operation information specifying the operation of the robot 20 with respect to the work piece 2, and the result information indicating the determination result regarding whether or not the operation of the robot 20 is correct in natural language sentence. As described above, the controller 10 distributes the steps to control the robot 20 by using a plurality of foundation models 132 to share the steps such as S3, S5 and S8. Thus, the user can confirm the result of each step such as S3, S5, or S8 executed by the controller 10 in a stepwise manner. Further, the user can easily confirm the progress level of each step performed by the controller 10 and the learning degree of each foundation model 132 in natural language sentence.

### Second Embodiment

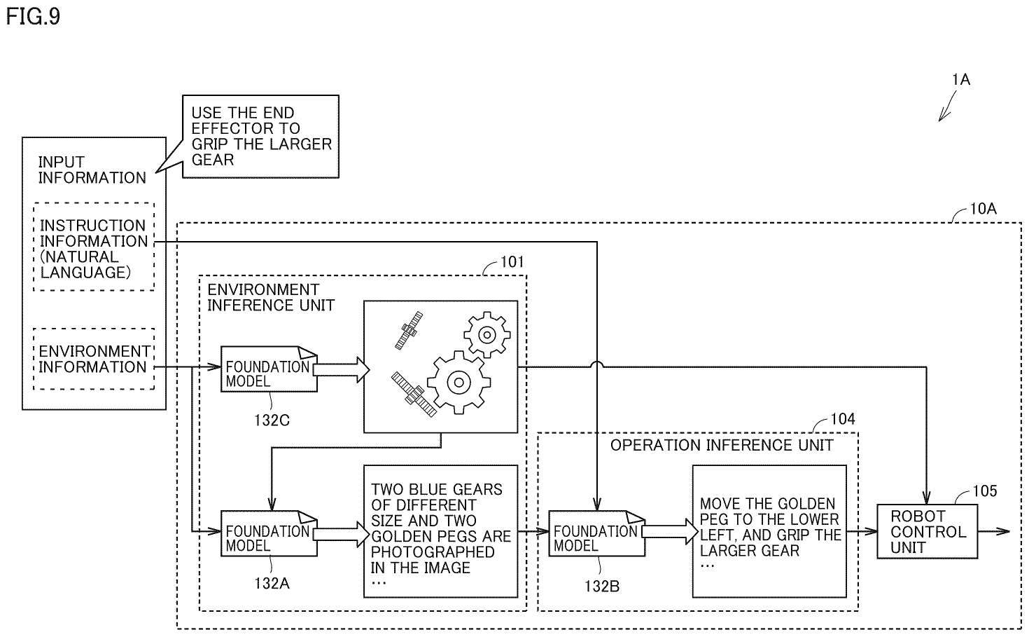

A control system 1A according to a second embodiment will be described with reference to FIG. 9. The control system 1A according to the second embodiment will be described only on portions different from the control system 1 according to the first embodiment.

FIG. 9 is a diagram illustrating an example process of the controller 10A in the control system 1A according to the second embodiment. As illustrated in FIG. 9, the environment inference unit 101 of the controller 10A uses the foundation model 132A to generate object information based on the environment information acquired from the sensor 30 and the segmentation result of the work piece 2 generated by the foundation model 132C.

Specifically, the environment inference unit 101 can use the foundation model 132C to segment the plurality of work pieces 2 photographed in the image so as to generate an image in which each of the plurality of work pieces 2 is distinguishably depicted. The environment inference unit 101 uses the foundation model 132A to refer to the image which is generated by the foundation model 132C and in which each work piece 2 is segmented, and generate object information which includes a natural language sentence indicating each work piece 2 photographed in the image.

As described above, since the environment inference unit 101 depicts each work piece 2 based on the image segmented by the foundation model 132C instead of the original image included in the environment information acquired from the sensor 30, it is possible to use the foundation model 132C to depict the work piece 2 with higher accuracy.

### Third Embodiment

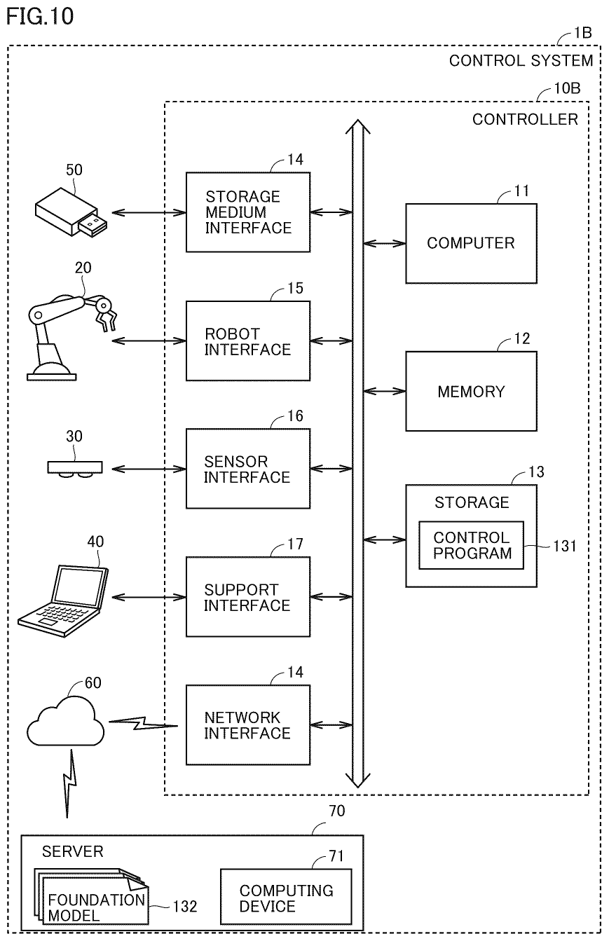

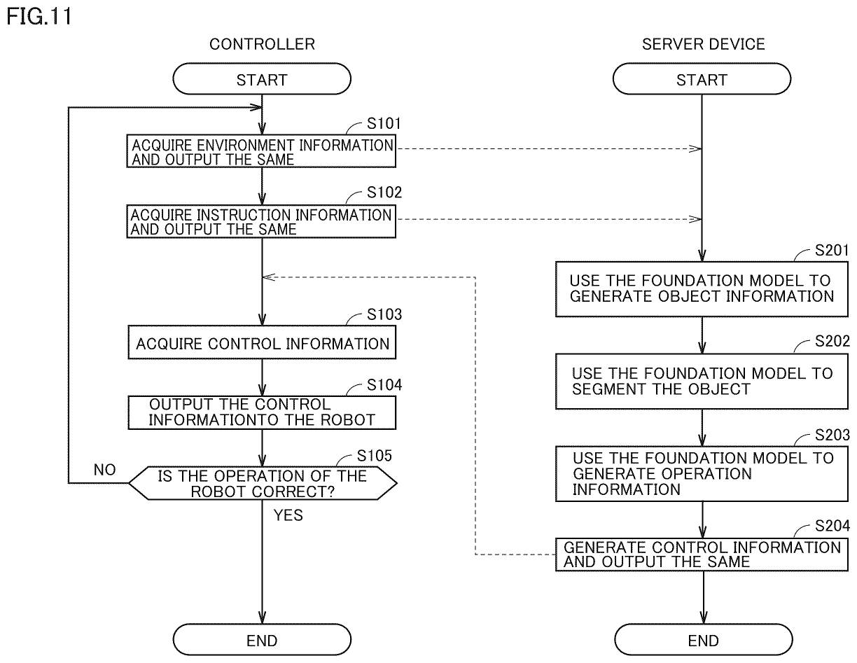

A control system 1B according to a third embodiment will be described with reference to FIGS. 10 and 11. The control system 1B according to the third embodiment will be described only on portions different from the control system 1 according to the first embodiment and the control system 1A according to the second embodiment.

FIG. 10 is a diagram illustrating the control system 1B according to the third embodiment. As illustrated in FIG. 10, the control system 1B includes a controller 10B and a server 70 communicably connected to the controller 10B. The server 70 may be, for example, a cloud computer.

In the control system 1B, the controller 10B does not store the foundation models 132A to 132C, and instead, the server 70 stores the foundation models 132A to 132C. The server 70 includes a computer 71. The computer 71 of the controller 10B executes a process to cause the controller 10B to control the robot 20 by using the foundation models 132A to 132C stored in the server 70.

FIG. 11 is a flowchart illustrating a process to be executed by the controller 10B and the server 70 in the control system 1B according to the third embodiment. The processing steps of the controller 10B are implemented by the computer 11 executing the control program 131. The processing steps of the server 70 are implemented by the computer 71.

As illustrated in FIG. 11, the controller 10B acquires, from the sensor 30, environment information indicating an observation result of an environment in which the work piece 2 is located, and outputs the environment information to the server 70 (S101). The controller 10B acquires, from the support device 40, instruction information indicating an instruction from the user to the robot 20, and outputs the instruction information to the server 70 (S102).

On the other hand, the server 70 uses the foundation model 132A to depict the work piece 2 photographed in the image in natural language sentence based on the environment information, and generate object information which includes the natural language sentence indicating the work piece 2 (S201). The server 70 uses the foundation model 132C to segment the work piece 2 photographed in the image in a distinguishable manner based on the environment information and specify the position information of each point in the point group constituting the segmented work piece 2 (S202).

The server 70 uses the foundation model 132B to generate operation information specifying an operation of the robot 20 based on the instruction information and the object information (S203). The server 70 generates control information to cause the controller 10B to control the robot 20 based on the position information and the operation information, outputs the control information to the controller 10B (S204), and ends the process related to the present flow.

In response, the controller 10B acquires the control information from the server 70 (S103). The controller 10B outputs the control information to the robot 20 (S104). The controller 10B uses the foundation model 132D to determine whether or not the operation of the robot 20 is correct based on the instruction information, the control information, and the operation result of the robot 20 (S105). When the operation of the robot 20 is not correct (NO in S105), the controller 10B returns to the step S101 and generates new operation information specifying the operation of the robot 20 by using the server 70. On the other hand, when the operation of the robot 20 is correct (YES in S105), the controller 10B ends the process related to the present flow.

As described above, in the control system 1B, the server 70 uses the foundation model 132A trained to generate information indicating an arbitrary work piece 2 to generate object information indicating the work piece 2 based on an observation result of an environment in which the work piece 2 is located and generate operation information specifying an operation of the robot 20 based on the object information. The server 70 generates control information to control the robot 20 and outputs the control information to the controller 10B. The controller 10B can operate the robot 20 with respect to an arbitrary work piece 2 by controlling the robot 20 in accordance with the control information acquired from the server 70. Thus, the controller 10 can provide a versatile control to operate the robot 20 with respect to an arbitrary work piece 2.

### Modification

The control systems 1, 1A, and 1B are not limited to the above-described embodiments, and various modifications and applications are possible.

The storage 13 of the controller 10B may store at least one of the foundation model 132A and the foundation model 132B. For example, the controller 10B may use the foundation model 132A to generate object information and output the object information to the server 70. The server 70 may use the foundation model 132B to generate operation information specifying an operation of the robot 20 based on the instruction information and the object information, and output the operation information to the controller 10B. Alternatively, the server 70 may use the foundation model 132A to generate object information and output the object information to the controller 10B. The controller 10B may use the foundation model 132B to generate operation information specifying an operation of the robot 20 based on the instruction information and the object information. Similarly, either the controller 10B or the server 70 may store each of the foundation model 132C and the foundation model 132D.

The object information may include attribute information indicating an attribute of the work piece 2. The attribute information may include at least one of the shape, the weight, the friction coefficient, the center of gravity, the inertia moment, and the rigidity of the work piece 2. Further, the operation inference unit 104 of the controller 10 may generate the operation information by using a learning model in which machine learning is performed on the attributes of the work piece 2 instead of using the foundation model 132B. For example, the environment inference unit 101 of the controller 10 may generate a natural language sentence indicating attributes of the work piece 2 such as the shape, the weight, the friction coefficient, the center of gravity, the inertia moment, and the rigidity by using the foundation model 132A, and output the sentence as the object information. Further, the operation inference unit 104 of the controller 10 may generate the operation information specifying the operation of the robot 20 based on the attribute of the work piece 2 included in the object information by using the learning model.

When the operation of the robot 20 according to the control information is not correct, the controller 10 may output, to the support device 40, notification information for notifying the user that the operation of the robot 20 is not correct. When receiving a feedback to the notification information from the user, the support device 40 may output an instruction to generate the operation information to the controller 10. The controller 10 may generate new operation information by using the foundation model 132B in accordance with a command from the user acquired via the support device 40.

Instead of determining whether or not the operation of the robot 20 is correct by using the foundation model 132D, the controller 10 may determine whether or not the operation of the robot 20 is correct by using another method. For example, the controller 10 may determine whether or not an abnormality has occurred in the operation of the robot 20 by using a sensor that detects the operation of the robot 20. In addition, the user may determine whether or not the operation of the robot 20 is correct, and the controller 10 may determine whether or not the operation of the robot 20 is correct based on a feedback to a determination result from the user acquired via the support device 40.

Only the “first inference model” may be a foundation model in which machine learning is performed on a non-specific learning target. In other words, the “second inference model”, the “third inference model”, and the “fourth inference model” may not be a foundation model but a learning model in which machine learning is performed on a specific learning target. In addition to the “first inference model”, at least one of the “second inference model”, the “third inference model” and the “fourth inference model” may be a foundation model, and the other models may be a learning model.

The controller 10 may not necessarily include the update unit 103. Further, in the controller 10, the operation inference unit 104 may not output the operation information to the storage unit 102. In other words, the controller 10 can generate the operation information based on the past object information, the past operation information, the past instruction information, and the past result information stored in the storage 13 without updating the information related to the work piece 2.

### Appendixes

It will be understood by those skilled in the art that the embodiments described above are specific examples of the following aspects.

(First Aspect) A controller according to the present disclosure includes a storage that stores data to control a control target; and a computer that executes a process to control the control target. The computer acquires environment information indicating an observation result of an environment in which a target object to be operated by the control target is located, and acquires instruction information indicating an instruction from a user to the control target, the instruction including an instruction related to the target object, the computer includes a first inference unit that generates object information indicating the target object based on the acquired environment information by using a first inference model, the first inference model being configured to generate information indicating an arbitrary object based on information indicating an observation result of an environment in which the arbitrary object is located, and a second inference unit that generates operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and the computer executes a process to control the control target based on the operation information.

(Second Aspect) In the controller according to the first aspect, the second inference model is configured to generate information specifying an operation of the control target which includes an operation with respect to the arbitrary object based on information indicating the arbitrary object as the information related to the object.

(Third Aspect) In the controller according to the first or second aspect, the operation information includes a natural language sentence specifying an operation of the control target.

(Fourth Aspect) In the controller according to any one of the first to third aspects, the object information includes a natural language sentence indicating the target object.

(Fifth Aspect) In the controller according to any one of the first to fourth aspects, the object information includes attribute information indicating an attribute of the target object.

(Sixth Aspect) In the controller according to any one of the first to fifth aspects, the attribute information includes at least one of a shape, a weight, a friction coefficient, a center of gravity, an inertia moment, and a rigidity of the target object.

(Seventh Aspect) In the controller according to any one of the first to sixth aspects, the environment information includes an environment image obtained by photographing an environment in which the target object is located, the computer further includes a third inference unit that acquires position information of the target object in the environment image based on the environment image by using a third inference model, the third inference model being configured to segment an object included in an image based on the image including the object, and the computer is configured to execute a process to control the control target based on the operation information and the position information.

(Eighth Aspect) In the controller according to the seventh aspect, the third inference model is configured to segment the arbitrary object included in an image based on the image including the arbitrary object.

(Ninth Aspect) In the controller according to any one of the first to eighth aspects, the computer is configured to output control information indicating a control content for the control target to the control target as the process to control the control target, determine whether or not an operation of the control target according to the control information is correct, and generate new operation information specifying an operation of the control target when the operation of the control target is not correct.

(Tenth Aspect) In the controller according to the ninth aspect, the storage is configured to accumulatively store the object information, the operation information, and an operation result of the control target, and the computer generates the new operation information based on information stored in the storage.

(Eleventh Aspect) In the controller according to the ninth or tenth aspect, the computer further includes a fourth inference unit that determines whether or not an operation of the control target is correct based on the instruction information, the control information, and an operation result of the control target according to the control information by using a fourth inference model, the fourth inference model being configured to determine whether or not the operation is correct based on information indicating a control instruction to the control target, information indicating a control content for the control target, and information indicating an operation result of the control target.

(Twelfth Aspect) In the controller according to the eleventh aspect, the fourth inference model is configured to generate a natural language sentence indicating a determination result regarding whether or not the operation of the control target is correct.

(Thirteenth Aspect) In the controller according to any one of the ninth to twelfth aspects, the computer is configured to notify the user that the operation of the control target is not correct when the operation of the control target is not correct, and generate the new operation information according to an instruction from the user.

(Fourteenth Aspect) In the controller according to the seventh or eighth aspect, the computer is configured to generate, by using the first inference model, the object information based on a segmentation result of the third inference model.

(Fifteenth Aspect) In the controller according to any one of the first to fourteenth aspects, the storage is configured to store at least one of the first inference model and the second inference model.

(Sixteenth Aspect) A control method according to the present disclosure includes, as a process to be executed by a computer, acquiring environment information indicating an observation result of an environment in which a target object to be operated by the control target is located, acquiring instruction information indicating an instruction from a user to the control target, the instruction including an instruction related to the target object, generating object information indicating the target object based on the acquired environment information by using a first inference model, the first inference model being configured to generate information indicating an arbitrary object based on information indicating an observation result of an environment in which the arbitrary object is located, generating operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and executing a process to control the control target based on the operation information.

(Seventeenth Aspect) A control system according to the present disclosure includes a controller that controls a control target, and a server communicably connected to the controller. The server includes a computer that executes a process to cause the controller to control the control target. The computer is configured to acquire environment information indicating an observation result of an environment in which a target object to be operated by the control target is located, and acquire instruction information indicating an instruction from a user to the control target, the instruction including an instruction related to the target object, the computer includes a first inference unit that generates object information indicating the target object based on the acquired environment information by using a first inference model, the first inference model being configured to generate information indicating an arbitrary object based on information indicating an observation result of an environment in which the arbitrary object is located, and a second inference unit that generates operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and the computer is configured to generate control information to control the control target based on the operation information and output the control information to the controller.

It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

1, 1A, 1B, 1X: control system; 2: work piece; 3: stage; 10, 10A, 10B, 10X: controller; 11: computer; 12: memory; 13: storage; 14: storage medium interface; 15: robot interface; 16: sensor interface; 17: support interface; 18: network interface; 20: robot; 21: base; 22: arm; 23: end effector; 30: sensor; 40: support device; 41: input unit; 42: display; 50: storage medium; 60: internet; 70: server; 71: computer; 101: environment inference unit; 102: storage unit; 103: update unit; 104, 104X: operation inference unit; 105, 105X: robot control unit; 106: determination unit; 131: control program; 132, 132A, 132B, 132C, 132D: foundation model; 132X: learning model.

What is claimed is:

1. A controller that controls a control target configured to perform a specified operation, the controller comprising:
a storage that stores data to control the control target; and
a computer that executes a process to control the control target, wherein the computer is configured to:
acquire environment information indicating an observation result of an environment in which a target object to be operated by the control target is located; and
acquire instruction information indicating an instruction from a user to the control target, the instruction including an instruction related to the target object,
the computer includes:
a first inference unit that generates object information indicating the target object based on the acquired environment information by using a first inference model, the first inference model being configured to generate information indicating an arbitrary object based on information indicating an observation result of an environment in which the arbitrary object is located;, and
a second inference unit that generates operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and
the computer is configured to execute a process to control the control target based on the operation information.

2. The controller according to claim 1, wherein
the second inference model is configured to generate information specifying an operation of the control target which includes an operation with respect to the arbitrary object based on information indicating the arbitrary object as the information related to the object.

3. The controller according to claim 2, wherein
the operation information includes a natural language sentence specifying an operation of the control target.

4. The controller according to claim 1, wherein
the object information includes a natural language sentence indicating the target object.

5. The controller according to claim 1, wherein
the object information includes attribute information indicating an attribute of the target object.

6. The controller according to claim 5, wherein
the attribute information includes at least one of a shape, a weight, a friction coefficient, a center of gravity, an inertia moment, and a rigidity of the target object.

7. The controller according to claim 1, wherein
the environment information includes an environment image obtained by photographing an environment in which the target object is located,
the computer further includes a third inference unit that acquires position information of the target object in the environment image based on the environment image by using a third inference model, the third inference model being configured to segment an object included in an image based on the image including the object, and
the computer is configured to execute a process to control the control target based on the operation information and the position information.

8. The controller according to claim 7, wherein
the third inference model is configured to segment the arbitrary object included in an image based on the image including the arbitrary object.

9. The controller according to claim 1, wherein
the computer is configured to:
output control information indicating a control content for the control target to the control target as the process to control the control target;
determine whether or not an operation of the control target according to the control information is correct; and
generate new operation information specifying an operation of the control target when the operation of the control target is not correct.

10. The controller according to claim 9, wherein
the storage is configured to accumulatively store the object information, the operation information, and an operation result of the control target, and
the computer is configured to generate the new operation information based on information stored in the storage.

11. The controller according to claim 9, wherein
the computer further includes a fourth inference unit that determines whether or not an operation of the control target is correct based on the instruction information, the control information, and an operation result of the control target according to the control information by using a fourth inference model, the fourth inference model being configured to determine whether or not the operation is correct based on information indicating a control instruction to the control target, information indicating a control content for the control target, and information indicating an operation result of the control target.

12. The controller according to claim 11, wherein
the fourth inference model is configured to generate a natural language sentence indicating a determination result regarding whether or not the operation of the control target is correct.

13. The controller according to claim 9, wherein
the computer is configured to:
notify the user that the operation of the control target is not correct when the operation of the control target is not correct: and
generate the new operation information according to an instruction from the user.

14. The controller according to claim 7, wherein
the computer is configured to generate, by using the first inference model, the object information based on a segmentation result of the third inference model.

15. The controller according to claim 1, wherein
the storage is configured to store at least one of the first inference model and the second inference model.

16. A control method of controlling a control target configured to perform a specified operation, the control method comprising:
as a process to be executed by a computer,
acquiring environment information indicating an observation result of an environment in which a target object to be operated by the control target is located;
acquiring instruction information indicating an instruction from a user to the control target, the instruction including an instruction related to the target object;
generating object information indicating the target object based on the acquired environment information by using a first inference model, the first inference model being configured to generate information indicating an arbitrary object based on information indicating an observation result of an environment in which the arbitrary object is located;
generating operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object; and
executing a process to control the control target based on the operation information.

17. A control system that controls a control target configured to perform a specified operation, the control system comprising:
a controller that controls the control target; and
a server communicably connected to the controller, wherein
the server includes a computer that executes a process to cause the controller to control the control target, the computer is configured to:
acquire environment information indicating an observation result of an environment in which a target object to be operated by the control target is located; and
acquire instruction information indicating an instruction from a user to the control target, the instruction including an instruction related to the target object,
the computer includes
a first inference unit that generates object information indicating the target object based on the acquired environment information by using a first inference model, the first inference model being configured to generate information indicating an arbitrary object based on information indicating an observation result of an environment in which the arbitrary object is located, and
a second inference unit that generates operation information specifying an operation of the control target which includes an operation with respect to the target object based on the acquired instruction information and the object information by using a second inference model, the second inference model being configured to generate information specifying an operation of the control target which includes an operation with respect to an object based on information related to the object and information indicating an instruction related to the control target which includes an instruction related to the object, and
the computer is configured to generate control information to control the control target based on the operation information and output the control information to the controller.
